(19) United States
(12) Patent Application Publication
(10) Pub. No.: US 2024/0067021 A1
(43) Pub. Date: Feb. 29, 2024

(54) CHARGING MANAGEMENT SYSTEM

(71) Applicants: HYUNDAI MOTOR COMPANY, Seoul (KR); KIA CORPORATION, Seoul (KR)

(72) Inventor: Sueng Ho Lee, Seoul (KR)

(21) Appl. No.: 18/099,022

(22) Filed: Jan. 19, 2023

(30) Foreign Application Priority Data
Aug. 24, 2022 (KR) 10-2022-0106287

(51) Int. Cl. B60L 53/62; B60L 5/00; B60L 53/51

(52) U.S. Cl. CPC B60L 53/62; B60L 5/005; B60L 53/51

(57) ABSTRACT

A charging management system includes a determining part configured to compare a state of charge (SOC) of a vehicle battery with a preset reference value, a distribution controller configured to control a distribution of generated electric power to allow the electric power generated by a solar power device to be supplied to the vehicle battery or a wireless charging road on the basis of the comparison result of the determining part, and a power reception controller configured to control power reception from the wireless charging road based on the comparison result of the determining part.

### CROSS REFERENCE TO RELATED APPLICATIONS

The present application claims priority of Korean Patent Application No. 10-2022-0106287 filed on Aug. 24, 2022, the entire contents of which is incorporated herein for all purposes by this reference.

### BACKGROUND

### Technical Field

The present disclosure relates to a charging management system, and more particularly, to a charging management system for controlling distribution of generated power and power reception of a vehicle capable of performing power exchange between solar power generation and a wireless charging road.

### Background

With the electrification of vehicles, various studies on electrified vehicle-related technologies are being conducted. In particular, a charging technology, which is one of the core technologies of electrified vehicles, is directly related to the future global environment and energy policies of each country, as well as driving efficiency and convenience, and thus various studies related to the charging technology are being conducted.

The electrified vehicle has an advantage of being more eco-friendly than an internal combustion engine vehicle because the electrified vehicle uses electric energy as a power source. However, when compared to the internal combustion engine vehicle being supplied with a power source through refueling, the electrified vehicle has a problem of taking a relatively long time for charging. Accordingly, technologies for charging an electrified vehicle during driving, such as charging through solar power generation and charging through a wireless charging road, have been proposed.

The solar power generation technology is a technology for converting solar energy into electric energy during driving through a power generation device such as a solar panel provided in the vehicle and transferring the electric energy to a vehicle battery for charging. Thus, the vehicle can be charged during driving without limitation due to a driving route, and a burden in terms of cost can be reduced. However, there is a disadvantage in that the charging depends on the weather conditions, and the amount of power supply is not constant.

The charging technology through a wireless charging road is a technology for supplying electric power of an energy storage system (ESS) or a system power source in a wireless manner through a road capable of exchanging electric power with a vehicle. The charging technology through a wireless charging road also allows the vehicle to be charged during driving, thereby not requiring an extra time for charging. In particular, when the electric power stored in the ESS is supplied through a wireless charging road, there is an advantage of being able to supply electric power by being coupled to eco-friendly renewable energy sources such as solar, wind power, and the like, and to store electric power during periods of low demand and supply the stored electric power at peak times. However, the charging technology through a wireless charging road depends on a charging infrastructure and limits a driving route of the vehicle. In addition, when compared to the solar power generation method, the charging technology through a wireless charging road has a disadvantage in terms of cost.

In addition, since the above proposed technologies are independently applied to vehicles, there is a disappointment that the utilization range of electric power is limited.

Thus, there is a need to propose a method of interconnecting the technologies to compensate for their own shortcomings and to efficiently utilize electric power.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to propose a charging management system for interconnecting a vehicle with each charging technology by controlling distribution of generated electric power obtained through solar power generation and controlling power exchange between the vehicle and a wireless charging road on the basis of a battery state of the vehicle.

It should be noted that objects of the present disclosure are not limited to the above-described objects, and other objects which are not mentioned can be clearly understood those skilled in the art from the following descriptions.

According to one aspect, there is provided a charging management system including a determining part configured to compare a state of charge (SOC) of a vehicle battery with a preset reference value, when solar power generation is possible through a solar power device provided in the vehicle, and electric power exchange between the vehicle and a wireless charging road is possible, a distribution controller configured to control a distribution of generated electric power to allow the electric power generated by the solar power device to be supplied to the vehicle battery or the wireless charging road on the basis of a comparison result with a first reference value by the determining part, and when the electric power exchange between the vehicle and the wireless charging road is possible, a power reception controller configured to control power reception from the wireless charging road on the basis of a comparison result with a second reference value by the determining part.

When the SOC of the vehicle battery is greater than or equal to the first reference value, the distribution controller may supply the generated electric power to the wireless charging road.

In addition, when the SOC of the vehicle battery is less than the first reference value, the distribution controller may supply the generated electric power to the vehicle battery.

When the SOC of the vehicle battery is less than the second reference value, the power reception controller may allow the vehicle to receive electric power from the wireless charging road.

The determining part may determine whether an additional condition is satisfied, and when the SOC of the vehicle battery is greater than or equal to the second reference value, the power reception controller may allow the vehicle to receive electric power from the wireless charging road when the additional condition is satisfied.

The determining part may determine whether the additional condition is satisfied in consideration of at least one among a driving mode of the vehicle, a wireless charging request of the driver, and required power of the driver.

The first reference value may be less than the second reference value.

The determining part may determine whether electric power exchange is possible between the wireless charging road and the vehicle on the basis of a current location of the vehicle.

In addition, the determining part may determine whether the electric power exchange is possible on the basis of whether the vehicle is located on the wireless charging road.

In addition, when the vehicle is not located on the wireless charging road, the determining part may generate an entry request toward the wireless charging road.

In addition, when the SOC of the vehicle battery is greater than or equal to the third reference value, the determining part may not generate the entry request toward the wireless charging road.

In addition, the determining part may determine whether solar power generation is possible on the basis of weather information.

In addition, when the SOC of the vehicle is less than the third reference value, the solar power generation is not possible, and the electric power exchange between the vehicle and the wireless charging road is not possible, the determining part may generate a charging station search request.

When a supply interruption request is generated while the generated electric power is supplied to the wireless charging road, the distribution controller may interrupt the supply of the generated electric power to the wireless charging road.

The determining part, the distribution controller, and the power reception controller may be provided in the vehicle.

The charging management system according to one embodiment of the present disclosure may further include a communication part configure to transmit charging information, which includes at least one of an amount of electric power supplied to the wireless charging road or an amount of electric power received from the wireless charging road, to an external server.

The communication part may receive fee information according to the electric power exchange between the vehicle and the wireless charging road from the external server.

In addition, the communication part may be provided in the vehicle.

### BRIEF DESCRIPTION OF THE FIGURES

The above and other objects, features and other advantages of the present disclosure will be more clearly understood from the following detailed description when taken in conjunction with the accompanying drawings, in which:

FIG. 1 is a diagram illustrating an example of an electrified vehicle charging system applicable to embodiments of the present disclosure;

FIG. 2 is a diagram illustrating a configuration of a charging management system according to one embodiment of the present disclosure;

FIG. 3 is a diagram illustrating an example of a case in which power distribution and reception control are performed on the basis of a state of charge (SOC) of a vehicle battery according to one embodiment of the present disclosure;

FIG. 4 is a diagram illustrating a vehicle which enters into and departs from a wireless charging road according to one embodiment of the present disclosure;

FIG. 5 is a diagram illustrating a function of a communication part according to one embodiment of the present disclosure; and

FIG. 6 is a flowchart illustrating a control process of a charging management system according to one embodiment of the present disclosure.

### DETAILED DESCRIPTION

Specific structural and functional descriptions of the embodiments of the present disclosure disclosed in this disclosure or application are illustrative only for the purpose of describing the embodiments according to the present disclosure, and the embodiments according to the present disclosure may be implemented in various forms and should not be construed as being limited to embodiments described in the present specification or application.

The embodiments according to the present disclosure may be variously modified and may have various forms, so that specific embodiments will be illustrated in the drawings and be described in detail in the present specification or application. It should be understood, however, that it is not intended to limit the embodiments according to the concept of the present disclosure to specific disclosure forms, but it includes all modifications, equivalents, and alternatives falling within the spirit and scope of the present disclosure.

Unless defined otherwise, all terms including technical or scientific terms used herein have the same meaning as commonly understood by those skilled in the art to which the present disclosure pertains. General terms that are defined in a dictionary shall be construed to have meanings that are consistent in the context of the relevant art and will not be interpreted as having an idealistic or excessively formalistic meaning unless clearly defined in the present specification.

Hereinafter, embodiments disclosed in the present specification will be described in detail with reference to the drawings. The same reference numerals are given to the same or similar components regardless of reference numerals, and a repetitive description thereof will be omitted.

As used herein, suffixes “module” and “portion” for a component of the present disclosure are used or interchangeably used solely for ease of preparation of the specification, and do not have different meanings and each of them does not function by itself.

Further, in the following description of embodiments disclosed herein, when a detailed description of a known related art is determined to obscure the gist of the embodiments disclosed herein, the detailed description thereof will be omitted. In addition, the accompanying drawings are merely for easy understanding of the embodiments disclosed in the present specification, the technical spirit disclosed in the present specification is not limited by the accompanying drawings, and it should be understood to include all modifications, equivalents, and substitutes included in the spirit and scope of the present disclosure.

Terms including ordinal numbers such as first, second, and the like used herein may be used to describe various components, but the various components are not limited by these terms. The terms are used only for the purpose of distinguishing one component from another component.

When a component is referred to as being “connected” or “coupled” to another component, the component may be directly connected or coupled to another component, but it should be understood that sill another component may be present between the component and another component. On the contrary, when a component is referred to as being “directly connected” or “directly coupled” to another component, it should be understood that still another component may not be present between the component and another component.

Unless the context clearly dictates otherwise, the singular form includes the plural form.

In this disclosure, the terms “comprising,” “having,” or the like are used to specify that a feature, a number, a step, an operation, a component, an element, or a combination thereof described herein exists, and they do not preclude the possibility of the presence or addition of one or more other features, numbers, steps, operations, components, elements, or combinations thereof.

Prior to describing a charging management system according to embodiments of the present disclosure, a charging system of an electrified vehicle applicable to the embodiments will be described first.

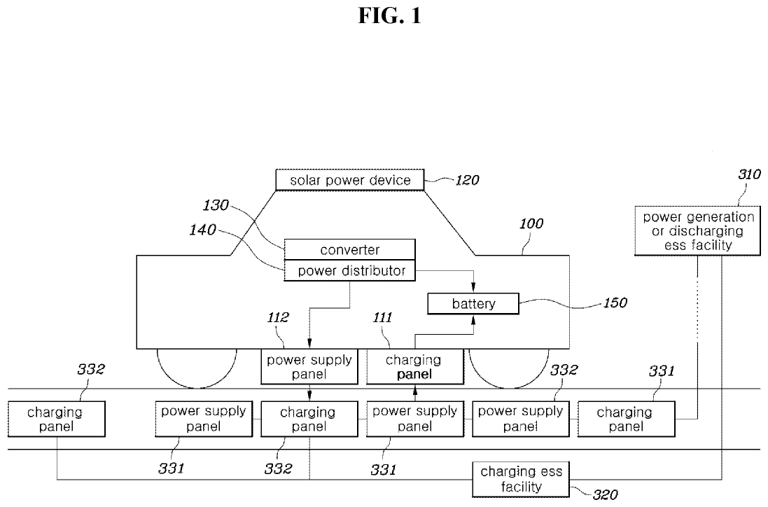

FIG. 1 is a diagram illustrating an example of an electrified vehicle charging system applicable to embodiments of the present disclosure. Referring to FIG. 1, a vehicle 100 provided with a solar power device 120 and a wireless charging road 330 capable of exchanging power with the vehicle 100 are shown. Hereinafter, each configuration and an operation of the charging system will be described in detail.

According to FIG. 1, the vehicle 100 applicable to the embodiments of the present disclosure includes the solar power device 120, a converter 130, a power distributor 140, a battery 150, a magnetic resonance-type charging panel 111, and a magnetic resonance-type power supply panel 112.

The solar power device 120 may be provided to be exposed at an upper end of the vehicle and may absorb solar energy through a solar panel or the like. The absorbed solar energy is converted into electric energy, and the electric energy may be converted into direct current (DC) through the converter 130. The electric energy passing through the converter 130 may be distributed to the vehicle battery 150 or the magnetic resonance-type power supply panel 112 through the power distributor 140. The electric energy distributed to the vehicle battery 150 is stored in the battery 150 and used in operation of the vehicle 100, such as driving. The electric energy distributed to the magnetic resonance-type power supply panel 112 is transmitted to a wireless charging road 330 through a magnetic resonance-type charging panel 332 and is used to charge a charging facility 320 connected to the wireless charging road 330.

In the charging system applicable to the embodiments of the present disclosure, the wireless charging road 330 is connected to a power generation or discharging facility 310 and the charging facility 320 and includes a magnetic resonance-type power supply panel 331 and the magnetic resonance-type charging panel 332.

The power generation or discharging facility 310 provides electric power supplied to the vehicle 100 through the wireless charging road 330. A discharging ESS facility or a system power source may correspond to the power generation or discharging facility 310, and the discharging ESS facility connected to the wireless charging road 330 may be charged again by the system power source.

The charging facility 320 may receive electric power from the vehicle through the wireless charging road 330, store the electric power, and transfer the electric power to the discharging facility 310 again so that the electric power may be transferred to the wireless charging road 330 again.

As shown in the drawings, the magnetic resonance-type power supply panel 331 and the charging panel 332 of the wireless charging road 330 may be provided separately or integrally. The power supply panel 331 and the charging panel 332 correspond to the charging panel 111 and the power supply panel 112, which are provided in the vehicle 100, respectively, and electric power may be exchanged through mutual magnetic resonance. In this case, the electric power is transmitted to the vehicle 100 through the power supply panel 331 of the wireless charging road 330 and the charging panel 111 of the vehicle 100 and is stored in the vehicle battery 150 to be used for driving. Alternatively, the electric power exchange between the vehicle 100 and the wireless charging road 330 is not necessarily limited to the above description, and any electric power exchange may be applicable to the embodiments of the present disclosure as long as it can supply and receive electric power to and from the vehicle 100 while the vehicle 100 is traveling without a separate electric power supply line.

FIG. 1 is merely one configuration example of an electrified vehicle charging system applicable to the embodiments of the present disclosure, and it will be apparent to those skilled in the art that the charging system applicable to the embodiments is not limited to the above configuration.

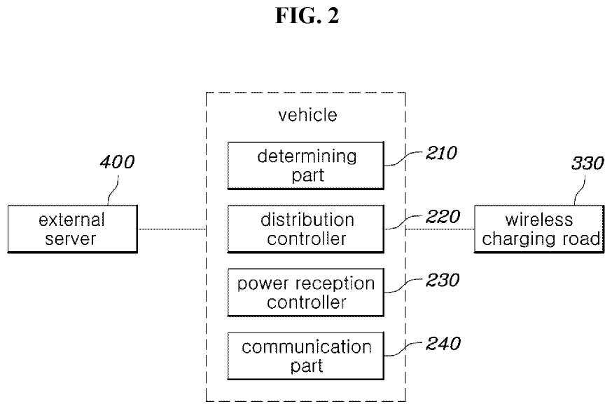

Hereinafter, the configuration of the charging management system according to the present disclosure will be described with reference to FIG. 2.

FIG. 2 is the diagram illustrating a configuration of the charging management system according to one embodiment of the present disclosure. Referring to FIG. 2, the charging management system according to an embodiment of the present disclosure may include a determining part 210, a distribution controller 220, a power reception controller 230, and a communication part 240 and perform interaction with an external server 400 and the wireless charging road 330.

More specifically, the charging management system according to the present disclosure includes a determining part 210 configured to compare an SOC of the vehicle battery 150 with a preset reference value, when solar power generation is possible through the solar power device 120 provided in the vehicle, and electric power exchange between the vehicle 100 and the wireless charging road 330 is possible, the distribution controller 220 configured to control a distribution of generated electric power to allow the electric power generated by the solar power device 120 to be supplied to the vehicle battery 150 or the wireless charging road 330 based on the comparison result of the determining part 210, and when the electric power exchange between the vehicle 100 and the wireless charging road 330 is possible, the power reception controller 230 configured to control power reception from the wireless charging road 330 based on the comparison result of the determining part 210, and the charging management system may further include the communication part 240 capable of communicating with the external server 400. Hereinafter, each component will be described in detail.

The determining part 210 may compare the SOC of the vehicle battery with a preset reference value and transmit the comparison result to the distribution controller 220 and the power reception controller 230. In this case, since the SOC of the vehicle battery is generally expressed in a unit of percentage (%), the preset reference value may also be set to have a unit of %.

In addition, the determining part 210 may determine whether solar power generation of the solar power device 120 provided in the vehicle is possible. In this case, the determination of whether the solar power generation is possible may be performed based on weather information. The weather information may be provided by analyzing the surrounding environments through a sensor provided in the vehicle or may be provided from the external server 400 such as a server of the Meteorological Administration. The supply of generated electric power to the wireless charging road 330 or the vehicle battery 150 is performed on the premise that the solar power generation is possible. By determining whether the solar power generation is possible through the determining part 210, it is possible to determine whether distribution control is performed. In addition, by determining whether the solar power generation is possible on the basis of the weather information, it is possible to improve accuracy of determining whether the solar power generation is possible.

When it is determined that solar power generation is not possible in spite of the need for charging the vehicle 100, it may be determined to receive electric power by the wireless charging road 330 as an alternative method. However, when even the electric power exchange between the vehicle 100 and the wireless charging road 330 is not possible, the determining part 210 may generate a charging station search request. When the charging station search request is generated, a charging station is searched through navigation or the like, and the vehicle may move to the searched charging station to be charged. Meanwhile, in this case, whether charging is necessary may be determined by the comparison result between the SOC of the vehicle battery and a preset reference value. For example, when the SOC of the vehicle battery is less than a third reference value, it may be determined that the charging is necessary, and in this case, the third reference value may be varied according to a driving condition such as a travel distance to a destination.

Then, the distribution controller 220 controls a distribution of the generated electric power based on the comparison result of the determining part 210. The distribution control of the generated electric power may be performed by controlling the power distributor 140 and the power supply panel 112 of the vehicle, and in this way, the generated electric power by the solar power device is supplied to the vehicle battery or the wireless charging road.

When the SOC of the vehicle battery is sufficient for the operation of the vehicle 100, there is no need to additionally receive the generated electric power so the electric power may be distributed and supplied to the wireless charging road 330. Conversely, when the SOC of the vehicle battery is insufficient to operate the vehicle 100, the electric power is supplied to the vehicle battery 150 instead of being supplied to the wireless charging road 330 so that the electric power required for the operation may be secured. In addition, according to a specific setting, a portion of the generated electric power may be distributed to the vehicle battery 150 and the remaining thereof may be distributed to the wireless charging road 330. In addition, as described above, whether the SOC of the vehicle battery is sufficient is determined according to the comparison result of the determining part 210.

Meanwhile, while the generated electric power is supplied to the wireless charging road under the control of the distribution controller 220, a supply interruption request may be generated by a driver or a wireless charging road manager. In this case, the distribution controller 220 may interrupt the supply of the generated electric power to the wireless charging road 330.

Subsequently, the power reception controller 230 controls power reception from the wireless charging road 330 on the basis of the comparison result of the determining part. The power reception control may be performed through control of the power charging panel 111 provided in the vehicle. In this way, the electric power may be transmitted from the power supply panel 331 of the wireless charging road 330 to the charging panel 111 of the vehicle. The electric power transmitted to the charging panel 111 is transferred to the vehicle battery 150 again, and through the above process, wireless charging of the vehicle 100 is performed by the wireless charging road 330.

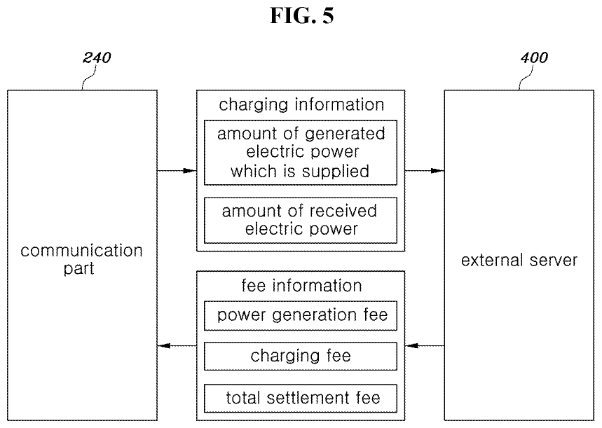

In addition, the charging management system according to one embodiment of the present disclosure may include the communication part 240. A detailed description related to the charging management system will be described below with reference to FIG. 5.

In the above-described charging management system, the determining part 210, the distribution controller 220, the power reception controller 230, and the communication part 240 may be provided in the vehicle and may be further implemented by adding a function to the existing components of the vehicle.

As the charging system according to the present disclosure is configured as described above, it is possible to control a transmission direction of the electric power based on the SOC of the vehicle. When the charging of the vehicle is required, the electric power is received from the wireless charging road 330 and the solar power device 120 and then the vehicle is charged, and when the charging of the vehicle is not required, electric power obtained through the solar power generation may be distributed and supplied to the wireless charging road 330. In this way, the driver may sell the surplus generated power to generate revenue or receive a reduction in a charging fee. In addition, an electrical grid including the ESS connected to the wireless charging road 330 or the like may receive the generated electric power from the vehicle 100 and supply the electric power back to the vehicle 100, thereby facilitating an electric power supply and demand. Consequently, in this way, it is possible to secure efficiency of the entire infrastructure including the electrical grid connected to the wireless charging road 330 as well as the solar power generation and the vehicle 100.

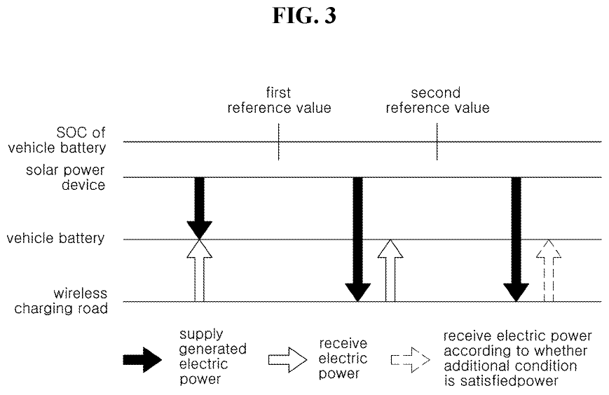

FIG. 2 is the diagram illustrating the entire configuration of the charging management system according to one embodiment of the present disclosure, and detailed descriptions of the comparison result of the determining part 210 and operations of the distribution controller 220 and the power reception controller 230 according to the comparison result will be described below with reference to FIG. 3.

FIG. 3 is a diagram illustrating an example of a case in which power distribution and reception control are preformed on the basis of an SOC of a vehicle battery according to one embodiment of the present disclosure.

Referring to FIG. 3, in a state in which the supply of the generated electric power is possible and the power exchange between the vehicle 100 and the wireless charging road 330 is possible, a movement flow of electric power for each section of the SOC of the vehicle battery divided into a first reference value and a second reference value is shown. First, as the comparison result of the determining part 210, when the SOC of the vehicle battery is greater than or equal to the first reference value, the distribution controller 220 according to one embodiment of the present disclosure supplies the electric power generated by the solar power device 120 to the wireless charging road 330. Conversely, when the SOC of the vehicle battery is less than the first reference value, the generated electric power is supplied to the vehicle battery 150. The first reference value which is a comparison target with the SOC of the vehicle battery becomes a control reference of the distribution controller, and with the first reference value, the distribution controller 220 may determine whether to use the generated electric power to charge the vehicle battery 150 or supply the generated electric power to the wireless charging road 330 and sell the generated electric power.

In addition, it is possible to change a driving strategy of the vehicle according to a setting of the first reference value. As the first reference value is set to be high, a section in which the generated electric power is supplied to the vehicle battery 150 is expanded so that a drivable distance may be increased or available electric power may be increased in the same cost condition. As the first reference value is set to be low, more electric power is supplied to the wireless charging road 330 so that an increase in power sales revenue can be expected.

As the comparison result of the determining part 210, when the SOC of the vehicle battery is less than the second reference value, the power reception controller 230 according to one embodiment of the present disclosure allows the vehicle 100 to receive the electric power from the wireless charging road 330. Conversely, when the SOC of the vehicle battery is greater than or equal to the second reference value, the power reception controller 230 determines whether to receive the electric power according to whether an additional condition is satisfied. When the SOC of the vehicle battery is greater than or equal to the second reference value, it may mean a state in which wireless charging is not essential so that the power reception controller 230 may control power reception according to whether an additional condition is satisfied to determine whether to receive the electric power from the wireless charging road 330 for each situation. In this case, whether the additional condition is satisfied is determined by the determining part 210. Specifically, the determining part 210 may determine whether the additional condition is satisfied in consideration of at least one among a driving mode of the vehicle, such as an electric vehicle (EV) mode and a hybrid EV (HEV) mode, a wireless charging request from the driver, and a power required by the driver. Through the above condition determination, it is possible to give the driver an option of the wireless charging or to reflect driving tendency or preference of the driver.

Meanwhile, as shown in FIG. 3, the first reference value serving as the generated power distribution criterion of the distribution controller 220 and the second reference value serving as the power reception criterion of the power reception controller 230 may have a relationship in which the first reference value is less than the second reference value. For example, the first reference value may be determined as 30% and the second reference value as 60%. Since the first reference value and the second reference value have the above relationship, the generated electric power may be supplied to the wireless charging road 330 in a section in which the SOC is sufficient so that a profit from electric power sales can be expected, and the generated electric power is received from the wireless charging road 330 in a section in which the SOC is low so that it is possible to reduce degradation in SOC during driving.

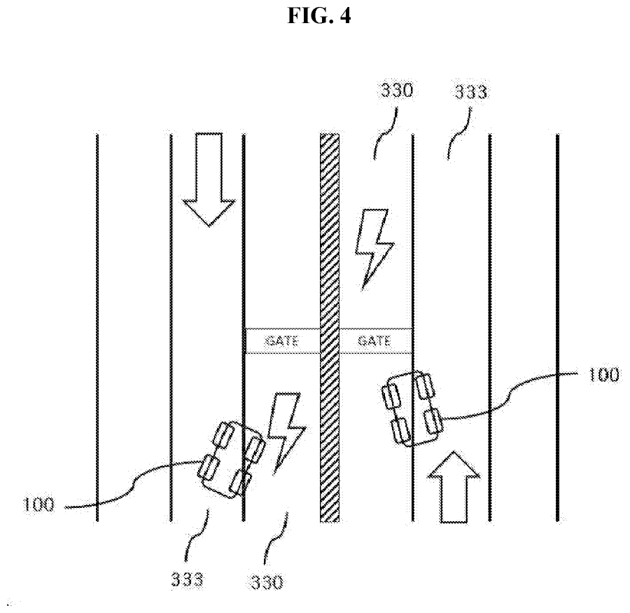

In the above description, the charging management system according to the embodiments of the present disclosure is based on the premise that the electric power exchange between the wireless charging road 330 and the vehicle 100 is possible. Hereinafter, control of the charging management system for the electric power exchange will be described with reference to FIG. 4.

FIG. 4 is a diagram illustrating a vehicle which enters into and departs from the wireless charging road according to one embodiment of the present disclosure. Referring to FIG. 4, the wireless charging road 330 may be implemented only in a portion of a road, and accordingly, it may be necessary to control the vehicle 100 to enter or depart from the wireless charging road 330.

In this regard, the determining part 210 according to one embodiment of the present disclosure may determine whether the electric power exchange is possible between the wireless charging road 330 and the vehicle 100 on the basis of a current location of the vehicle 100. The location of the vehicle may be identified by a global positioning system (GPS) or may be recognized through the wireless charging road 330. In addition, not only the location of the vehicle 100 but also whether the wireless charging system is approved or a state of the vehicle may be considered together.

Furthermore, the determining part 210 may determine whether the electric power exchange is possible on the basis of whether the vehicle 100 is located on the wireless charging road. When the vehicle 100 is not located on the wireless charging road 330 and is driving on a general road 333, the electric power exchange is not possible so that additional control is required. To this end, as the determination result, when the vehicle 100 is not located on the wireless charging road 330, the determining part 210 may generate a wireless charging road entry request. When the entry request is generated, the driver may directly drive the vehicle or the vehicle 100 may be allowed to enter the wireless charging road 330 through driving control of the vehicle 100. On the other hand, when the SOC of the vehicle battery is sufficient, there is no need for the vehicle 100 to enter the wireless charging road 330 for wireless charging. Therefore, when the SOC of the vehicle battery is greater than or equal to a third reference value, the determining part 210 prevents the entry request from being generated, thereby preventing an unnecessary entry request from being generated. That is, the third reference value is an SOC serving as a criterion for generating an entry request toward the wireless charging road 330 and may indicate whether the vehicle battery 150 needs to be charged in a non-entry state toward the wireless charging road 330. Meanwhile, the first reference value and the second reference value, which are described with reference to FIG. 3, are different from the third reference value in that the first reference value and the second reference value become criteria for determining a movement flow of the electric power in a state in which the vehicle 100 has already entered the wireless charging road 330. Accordingly, the third reference value preferably has a value that is greater than the first reference value or the second reference value.

In addition, the third reference value indicating whether charging is required in the non-entry state toward the wireless charging road 330 may act not only as a criterion for generating an entry request toward the wireless charging road 330 but also as a criterion for determining whether to start power generation of the solar power device 120. However, alternatively, whether to start the power generation may be determined only by whether the solar power generation is possible regardless of the SOC of the vehicle battery.

Meanwhile, when the electric power exchange with the wireless charging road 330 becomes unnecessary during driving on the wireless charging road 330, the driver may depart from the wireless charging road 330 by himself or herself or may allow a departure request to be generated by the determining part 210.

The above description relates to the operations of the determining part 210, the distribution controller 220, and the power reception controller 230 according to the embodiments of the present disclosure, and a description of the communication part 240 will be made below with reference to FIG. 5.

FIG. 5 is a diagram illustrating a function of the communication part according to one embodiment of the present disclosure. Referring to FIG. 5, the communication part 240 according to one embodiment of the present disclosure transmits charging information to the external server 400 and receives fee information from the external server 400.

The charging information may include at least one of an amount of electric power supplied to the wireless charging road or an amount of electric power received from the wireless charging road. The external server 400 receives the charging information, generates the fee information on the basis of the charging information, and transmits the fee information to the communication part 240. The fee information may include power generation fee, charging fee, and total settlement fee, and the total settlement fee may be money obtained by deducting the power generation fee from the charging fee.

In addition, the communication part 240 receiving the fee information may provide the fee information to the driver, and the fee information may be provided in real time. After checking the real-time fee information, the driver may choose whether to perform charging in a wireless manner on the basis of the real-time fee information.

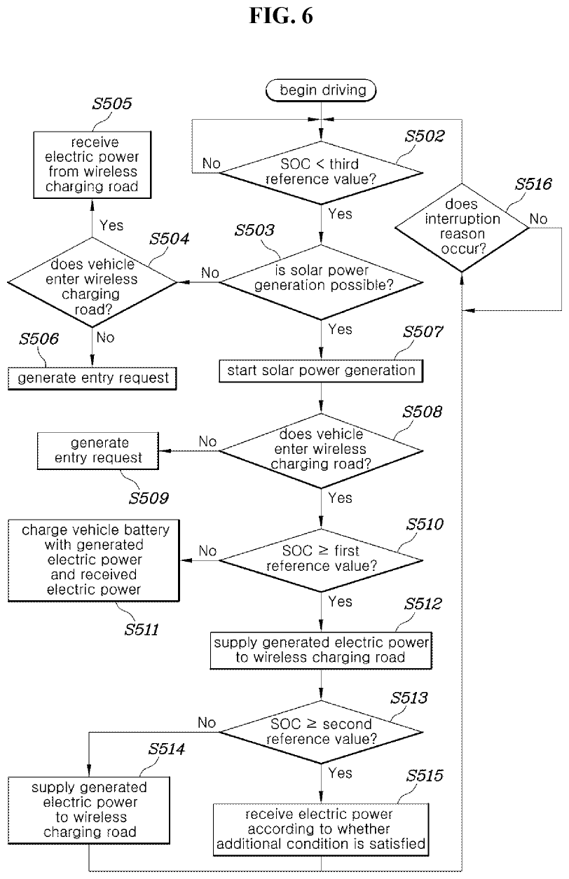

Hereinafter, a description will be made below in detail with reference to FIG. 6 showing the above-described contents as a flowchart.

FIG. 6 is a flowchart illustrating a control process of a charging management system according to one embodiment of the present disclosure.

The control process of a charging management system according to one embodiment of the present disclosure may include comparing an SOC of the vehicle battery with a preset reference value, and when solar power generation is possible through the solar power device 120 provided in the vehicle, and electric power exchange between the vehicle 100 and the wireless charging road 330 is possible, controlling, by the distribution controller 220, a distribution of generated electric power to allow the electric power generated by the solar power device 120 to be supplied to the vehicle battery 150 or the wireless charging road 330 on the basis of the comparison result of determining part 210, and when the electric power exchange between the vehicle 100 and the wireless charging road 330 is possible, controlling power reception, by the power reception controller 230, from the wireless charging road 330 on the basis of the comparison result of determining part 210. Hereinafter, the control process of a charging management system according to one embodiment of the present disclosure will be described in more detail.

Referring to FIG. 6, the control process starts when the vehicle 100 begins to drive at S501. The determining part 210 compares the SOC of the vehicle battery with a third reference value at S502, and as the determination result, when the SOC is less than the third reference value, the determining part 210 determines whether solar power generation is possible on the basis of weather information at S503. When the SOC is greater than or equal to the third reference value, it is determined that charging of the vehicle 100 is unnecessary, and thus the charging management system according to the present disclosure is not involved.

As the determination result, when the solar power generation is not possible, the determining part 210 checks whether the vehicle 100 enters the wireless charging road 330 at S504. When it is checked that the vehicle 100 enters the wireless charging road, it is determined that the electric power exchange between the vehicle 100 and the wireless charging road 330 is possible, and the power reception controller 230 allows the vehicle 100 to receive electric power from the wireless charging road 330 at S505. When it is checked that the vehicle 100 does not enter the wireless charging road 330, the determining part 210 generates an entry request at S506, and when the entry request is generated, the vehicle 100 is allowed to enter the wireless charging road 330 by the driver or vehicle control.

Meanwhile, in spite of the entry request, when the vehicle cannot enter the wireless charging road 330 and thus the electric power exchange between the vehicle 100 and the wireless charging road 330 is not possible, a charging station search request may be generated by the determining part 210.

As the determination result, when the solar power generation is possible (Yes of S503), the solar power generation is started and electric power is produced at S507. When the solar power generation is started, the determining part 210 determines whether the vehicle 100 enters the wireless charging road 330 for distribution of the generated electric power at S508, and when the vehicle 100 does not enter the wireless charging road 330, the determining part 210 generates the entry request at S509.

When it is determined that the vehicle 100 enters the wireless charging road 330 and thus the electric power exchange is possible, the determining part 210 compares the SOC of the vehicle battery with the first reference value at S510. As the comparison result, when the SOC is less than the first reference value, the distribution controller 220 controls the generated power to be supplied to the vehicle battery 150. On the premise that the first reference value is less than the second reference value, since the SOC has a value that is smaller than the second reference value, the power reception controller 230 controls the vehicle 100 to receive the electric power from the wireless charging road 330. Thus, when the SOC of the vehicle battery is less than the first reference value, both of the generated electric power and the received electric power are used for charging the vehicle battery by the distribution controller 220 and the power reception controller 230 at S511.

Otherwise, when the SOC of the vehicle battery is greater than or equal to the first reference value, the distribution controller 220 controls the generated electric power to be supplied to the wireless charging road 330 at S512. In addition, in order to determine whether to receive the electric power from the wireless charging road 330, the determining part 210 compares the SOC of the vehicle battery with the second reference value at S513. When the SOC is less than the second reference value, the power reception controller 230 allows the vehicle 100 to receive the electric power from the wireless charging road 330 at S514, and when the SOC is greater than or equal to the second reference value, the determining part 210 determines whether an additional condition is satisfied and then determines whether to receive the electric power according to whether the additional condition is satisfied at S515.

When an interruption reason, such as a supply interruption request, occurs while the generated electric power is supplied to the wireless charging road 330, the distribution controller 220 interrupts the supply of the generated electric power to the wireless charging road 330 at S516. In this case, the distribution controller 220 may supply the generated electric power to the vehicle battery 150.

As described above, according to various embodiments of the present disclosure, the supply flow of electric power is controlled so that a disadvantage of each charging technology can be compensated for, and the electric power can be efficiently used.

In particular, the electric power distribution and the electric power exchange are controlled on the basis of the state of the vehicle battery so that the electric power can be appropriately used according to specific situations.

Furthermore, in this way, it is possible to improve marketability of the vehicle and contribute to the improvement of the global environment.

As described above, according to various embodiments of the present disclosure, the supply flow of electric power is controlled so that a disadvantage of each charging technology can be compensated for, and the electric power can be efficiently used.

In particular, the electric power distribution and the electric power exchange are controlled on the basis of the state of the vehicle battery so that the electric power can be appropriately used according to specific situations.

Furthermore, in this way, it is possible to improve marketability of the vehicle and contribute to the improvement of the global environment.

The effects obtained by the present disclosure are not limited to the above-mentioned effects and other effects which are not mentioned can be clearly understood by those skilled in the art to which the present disclosure pertains from the above description.

As described above, although specific embodiments of the present disclosure have been described and illustrated, those skilled in the art will appreciate that various alternations and modifications are possible without departing from the technical spirit of the present disclosure as disclosed in the appended claims.

1. A charging management system, comprising:
a determining part configured to compare a state of charge (SOC) of a vehicle battery with a preset reference value, and to determine whether solar power generation is possible;
a distribution controller configured to control a distribution of generated electric power to allow the electric power generated by the solar power device to be supplied to the vehicle battery or the wireless charging road based on a comparison result with a first reference value by the determining part when it is determined that solar power generation is possible through a solar power device provided in the vehicle, and when it is determined that electric power exchange between the vehicle and a wireless charging road is possible; and
a power reception controller configured to control power reception from the wireless charging road based on a comparison result with a second reference value by the determining part when it is determined that the electric power exchange between the vehicle and the wireless charging road is possible.

2. The charging management system of claim 1, wherein, when the SOC of the vehicle battery is greater than or equal to the first reference value, the distribution controller supplies the generated electric power to the wireless charging road.

3. The charging management system of claim 1, wherein, when the SOC of the vehicle battery is less than the first reference value, the distribution controller supplies the generated electric power to the vehicle battery.

4. The charging management system of claim 1, wherein, when the SOC of the vehicle battery is less than the second reference value, the power reception controller allows the vehicle to receive electric power from the wireless charging road.

5. The charging management system of claim 1, wherein:
the determining part determines whether an additional condition is satisfied; and
when the SOC of the vehicle battery is greater than or equal to the second reference value, the power reception controller allows the vehicle to receive electric power from the wireless charging road when the additional condition is satisfied.

6. The charging management system of claim 5, wherein the determining part determines whether the additional condition is satisfied in consideration of at least one among a driving mode of the vehicle, a wireless charging request of the driver, and required power of the driver.

7. The charging management system of claim 1, wherein the first reference value is less than the second reference value.

8. The charging management system of claim 1, wherein the determining part determines whether electric power exchange is possible between the wireless charging road and the vehicle based on a current location of the vehicle.

9. The charging management system of claim 8, wherein the determining part determines whether the electric power exchange is possible based on whether the vehicle is located on the wireless charging road.

10. The charging management system of claim 9, wherein, when the vehicle is not located on the wireless charging road, the determining part generates an entry request toward the wireless charging road.

11. The charging management system of claim 10, wherein, when the SOC of the vehicle battery is greater than or equal to the third reference value, the determining part does not generate the entry request toward the wireless charging road.

12. The charging management system of claim 1, wherein the determining part determines whether solar power generation is possible based on weather information.

13. The charging management system of claim 1, wherein, when the SOC of the vehicle is less than the third reference value, the solar power generation is not possible, and the electric power exchange between the vehicle and the wireless charging road is not possible, the determining part generates a charging station search request.

14. The charging management system of claim 1, wherein, when a supply interruption request is generated while the generated electric power is supplied to the wireless charging road, the distribution controller interrupts the supply of the generated electric power to the wireless charging road.

15. The charging management system of claim 1, wherein, the determining part, the distribution controller, and the power reception controller are provided in the vehicle.

16. The charging management system of claim 1, further comprising:
a communication part configured to transmit charging information, which includes at least one of an amount of electric power supplied to the wireless charging road or an amount of electric power received from the wireless charging road, to an external server.

17. The charging management system of claim 16, wherein the communication part receives fee information according to the electric power exchange between the vehicle and the wireless charging road from the external server.

18. The charging management system of claim 16, wherein the communication part is provided in the vehicle.
